(19) United States
(12) Patent Application Publication
(10) Pub. No.: US 2024/0361052 A1
(43) Pub. Date: Oct. 31, 2024

(54) Thermal Energy Storage and Cooling Device

(71) Applicant: Ice Bear SPV #1, LLC, Costa Mesa, CA (US)

(72) Inventors: Joseph Ohne Raasch, Costa Mesa, CA (US); Joseph Condon, Oak Hills, CA (US)

(21) Appl. No.: 18/646,610

(22) Filed: Apr. 25, 2024

Related U.S. Application Data
(60) Provisional application No. 63/461,727, filed on Apr. 25, 2023.

(51) Int. Cl. F25B 41/40; F25B 7/00; F25B 39/02

(52) U.S. Cl. CPC F25B 41/40; F25B 7/00; F25B 39/02; F25B 2339/047

(57) ABSTRACT

The invention is a device as well as a system that stores and uses thermal energy in the form of ice to provide cooling to residences and other buildings. The device is a refrigerant-based thermal storage system with an ice-tank heat exchanger that cools a refrigerant that is then circulated to an air handler as part of an air conditioning system. The device integrates with commercial condenser devices.

### BACKGROUND OF THE INVENTION

### Field of the Invention

The present invention relates generally to systems that make, store, and use thermal energy in the form of ice to provide thermal storage and cooling to residences and commercial buildings.

### Description of the Background

With the increasing demands on peak demand power consumption, ice storage has been utilized to shift air conditioning power loads to off-peak times and rates. A need exists not only for load shifting from peak to off-peak periods, but also for increases in air conditioning unit capacity and efficiency. To commercialize advantages of thermal energy storage in residences and commercial buildings, thermal energy storage systems must have minimal manufacturing costs, maintain efficiency under varying operating conditions, and maintain flexibility in multiple refrigeration or air conditioning applications.

Systems for providing thermal stored energy have been previously disclosed in U.S. Pat. Nos. 7,363,772, 7,793,515, and 7,421,846 all by Ramachandran Narayanamurthy. All of these patents utilize ice storage to shift air conditioning loads from peak to off-peak electric rates to provide economic justification and are hereby incorporated by reference herein for all they teach and disclose.

### SUMMARY OF THE INVENTION

Disclosed are a device as well as a system and methods for storing thermal energy in the form of ice and using the stored thermal energy to provide cooling to residences and other buildings. The device is a refrigerant-based thermal storage system with an ice-tank heat exchanger that cools a refrigerant that is circulated to an air handler as part of an air conditioning system. The device integrates with commercial heating and cooling devices such as compressors, condensers, and air conditioning systems.

An embodiment of the present invention includes a refrigerant-based thermal energy storage and cooling system (also referred to by its acronym RTESC) that operates in three modes, an ice make mode, an ice melt mode, and a direct cooling mode.

In certain embodiments the invention works with a compressor, air conditioner, or heat pump (referred to as a condenser unit). The condenser unit cools warm refrigerant returned by the thermal energy device and returns the cool refrigerant to the device.

In certain embodiments, the invention generates cooling by pumping cold refrigerant through an evaporator coil that is integrated with an air handler, such as an air handler that is part of a commercial HVAC system.

The invention includes a refrigerant loop that circulates refrigerant from a vessel to an ice tank filled with a fluid capable of a phase change between liquid and solid, wherein the tank uses the refrigerant to cool the fluid and to freeze at least a portion of the fluid within the tank.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified. A brief introduction of the figures is below.

FIG. 1 illustrates an embodiment of a refrigerant-based thermal energy storage and cooling (RTESC) system that integrates with a condenser unit.

FIG. 2 illustrates an embodiment of a refrigerant-based thermal energy storage and cooling (RTESC) system that integrates with an air handler to provide air conditioning.

FIG. 3 illustrates a more detailed embodiment of the RTESC system illustrated in FIGS. 1 and 2.

FIG. 4 illustrates a configuration of the RTESC system that uses an ice-based primary heat exchanger to form ice during an ice-make cycle.

FIG. 5 illustrates a configuration of the RTESC system that uses the ice-based primary heat exchanger during an ice-melt cycle to provide cooling.

FIG. 6 illustrates a configuration of the RTESC system that bypasses the primary heat exchanger when providing cooling.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

While this invention is susceptible to embodiment in many different forms, there is shown in the drawings and will be described herein in detail specific embodiments thereof with the understanding that the present disclosure is to be considered as an exemplification of the principles of the invention and is not to be limited to the specific embodiments described.

The disclosed embodiments overcome the disadvantages and limitations of the prior art by providing a refrigerant-based thermal storage system and device wherein an ice-tank heat exchanger can be integrated with commercial HVAC components to provide a system that reduces the demand for electricity to operate an air conditioner during peak periods.

### Definitions

As used herein the following terms have the meanings given below:

Thermal energy storage system—as used herein, refers to a system that stores energy and discharges energy in thermal form. Typically, the stored energy is in the form of a liquid that is stored at a higher or lower temperature than ambient temperature. More specifically, certain embodiments store energy in the form of ice or cold water.

Refrigerant—as used herein is a fluid used in the refrigeration cycle of air conditioning systems and heat pumps where they undergo a repeated phase transition from a liquid to a gas (or vapor) and back again. An example of a refrigerant that may be used with the invention is R-410A, which has a boiling point of −48.5 C.

Condenser unit—as used herein condenser unit receives refrigerant in vapor phase, liquid phase or in partial liquid and partial vapor phase and generates cool liquid refrigerant. A condenser unit typically includes both a compressor and a condenser. A condenser unit may be the outdoor portion of an air conditioning or HVAC device or system, a commercial condenser, or a heat pump.

### Overview

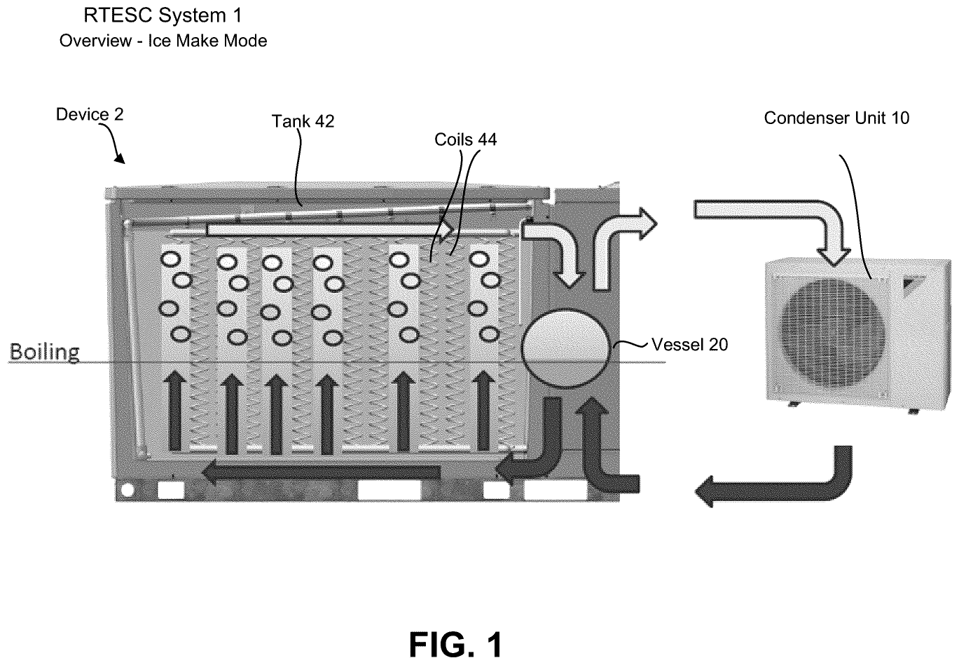

FIG. 1 provides an overview of the operation of a thermal storage and cooling device 2 (hereinafter referred to simply as device 2) operating with a commercial condenser unit 10 to make ice. Condenser unit 10 may be the outdoor portion of an air conditioning or HVAC device or system, a commercial condenser, or a heat pump. As used herein, condenser unit 10 is capable of receiving refrigerant in vapor phase, liquid phase or in partial liquid and partial vapor phase and generating cool liquid refrigerant. Condenser unit 10 typically includes a condenser which condenses refrigerant vapor into liquid phase.

During ice make mode, condenser unit 10 directs cold refrigerant into a vessel 20. Vessel 20 directs the cold refrigerant into and through heat exchange coils 44 (henceforth referred to coils 44) that run vertically through a tank 42 that holds water and ice. Due to the low boiling temperature of the refrigerant the relatively warmer water found at the bottom of tank 42 boils the refrigerant which changes to gaseous phase and rises through coils 44. The refrigerant flowing in coils 44 absorbs heat from the surrounding water and effectively freezes the water to generate ice. Effectively, when device 2 operates in ice make mode tank 42 in conjunction with coils 44 form a heat exchanger, transforming cold liquid refrigerant into warm refrigerant vapor and in the process freezing water to make ice.

Refrigerant in vapor form rises to the top of tank 42 where it is piped into the top of vessel 20. The horizontal line in FIG. 1 marked boiling, indicates that liquid remains at the bottom of vessel 20 and tank 42 and above that line the boiling action transforms the liquid refrigerant to a vapor form.

Finally, to complete the cycle, refrigerant in gas form is sucked out of vessel 20 and piped back to condenser unit 10 which transforms it back into liquid form.

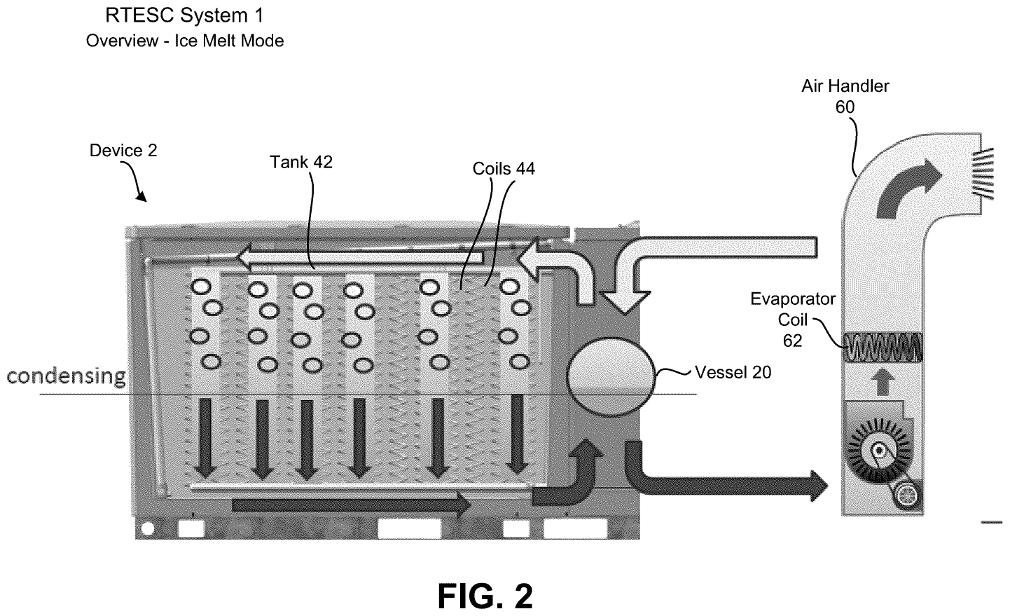

FIG. 2 provides an overview of the operation of device 2 operating in conjunction with an air handler 60 to melt ice stored in tank 42 to generate cold air, i.e. air conditioning. It is assumed that before entering an ice melt mode device 2 was previously operated in a ice make mode to form the water in tank 42 into a solid block of ice or at least a partial block of ice.

Air handler 60 generates cool air inside a building or residence that is blown through ductwork and thereby distributed within a building. In the process, refrigerant flowing through air handler 60 is heated. The heated refrigerant, which may be in vapor form or partial vapor and partial liquid form is returned to vessel 20. The warmer vapor phase refrigerant is then sucked into tank 42 at the top where it flows or descends downward through coils 44. The warmer gas melts the surrounding ice, which flows to the bottom of tank 42. The refrigerant accordingly loses temperature and condenses, i.e. returns to liquid form, as it descends through coils 44. The cool refrigerant is then piped back to vessel 20. Cool refrigerant is then pumped into an evaporator coil 62 that is integrated with air handler 60. Air handler 60, which is equipped with a fan, blows room temperature air or outside air across evaporator coil 62 to generate cool air.

Finally, to complete the cycle, the cool refrigerant in liquid or partial liquid and gas is sucked returned to vessel 20.

Effectively, when device 2 operates in ice melt mode, tank 42 in conjunction with coils 44 form a condenser that transforms warm refrigerant in vapor form into cold liquid refrigerant and in the process melts ice inside tank 42 into water.

The horizontal line in FIG. 2 marked condensing indicates that refrigerant in vapor form enters coils 44 from the top and condenses into a liquid as the vapor reaches the condensing line. Below the condensing line the refrigerant is in liquid form.

### Detailed Descriptions of Operating Modes

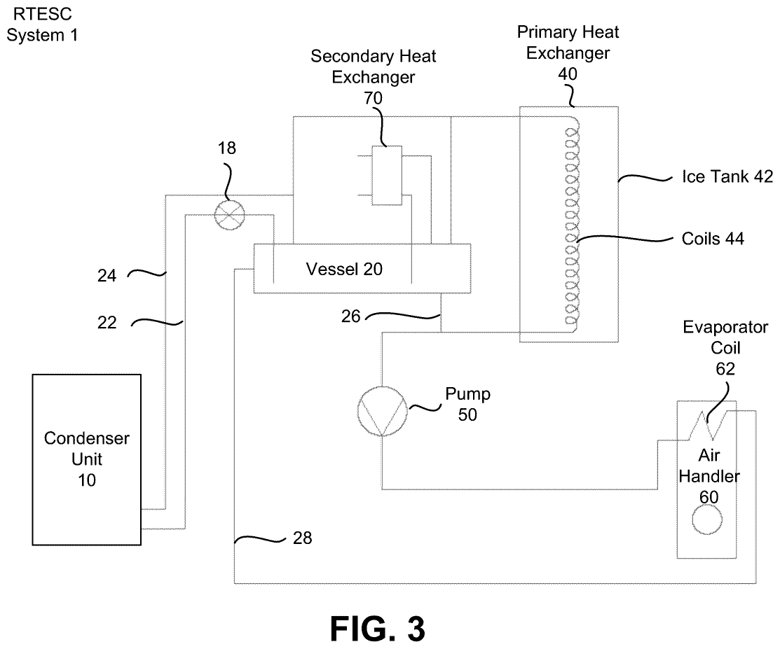

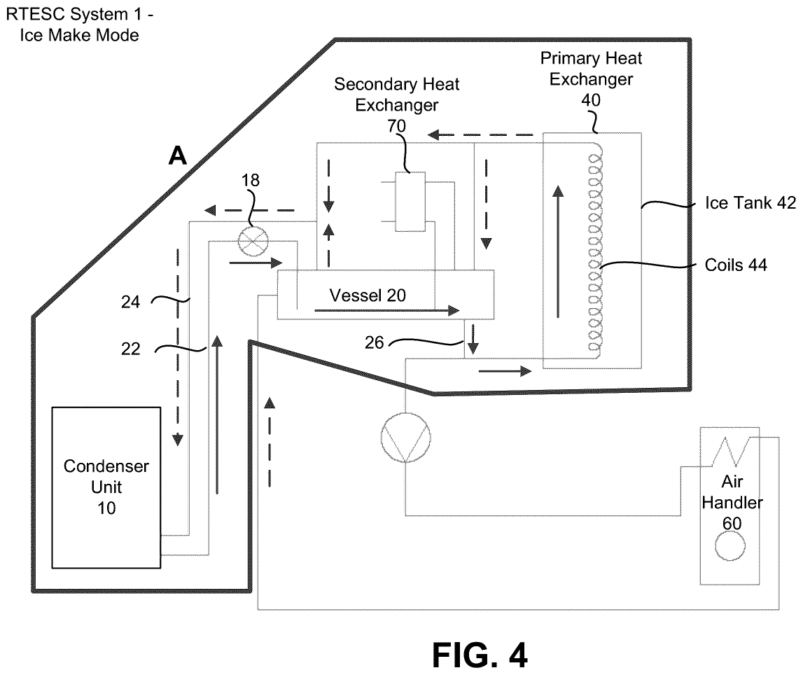

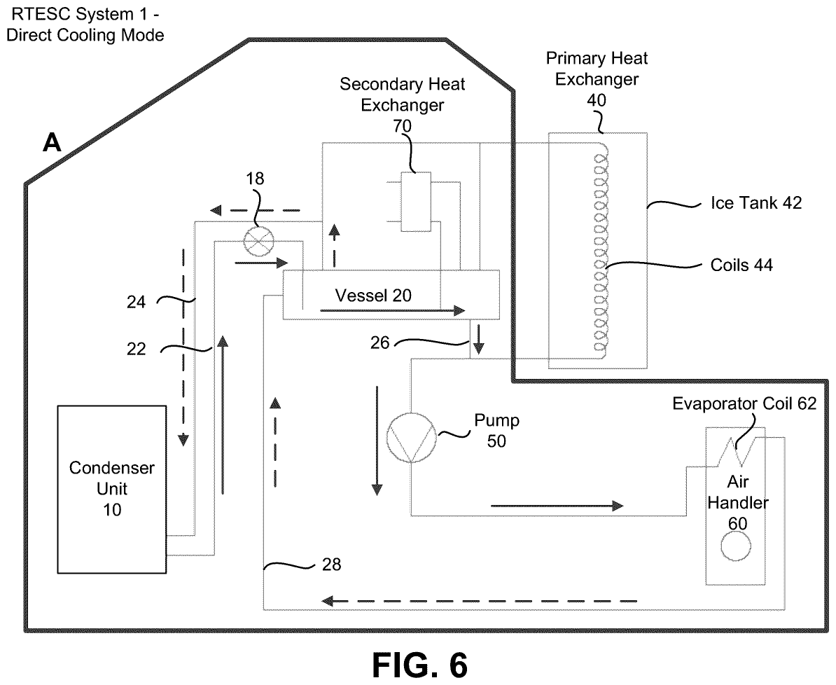

FIG. 3 illustrates a detailed embodiment of refrigerant-based thermal energy storage and cooling system 1 (also referred to by its acronym RTESC 1) that includes device 2. RTESC 1 operates in three modes, an ice make mode, an ice melt mode, and a direct cooling mode, which are described in further detail with reference to FIGS. 4-6.

As illustrated in FIG. 3, device 2 integrates with a condenser unit 10, and an air handler 60. Either or both of condenser unit 10 and air handler 60 may be external, independent, commercial devices such as a condenser, compressor, air conditioning system, heat pump, or HVAC system. Alternatively, either or both of condenser unit 10 and air handler 60, may be pre-integrated with device 2 and offered as a complete system.

Condenser unit 10 receives a stream of refrigerant in gas, liquid or partial gas and partial liquid form to generate a stream of liquid refrigerant that is directed through a supply line 22 to device 2. As previously discussed, condenser unit 10 is typically part of an air conditioning system such as a heat pump or HVAC system that includes a condenser.

Supply line 22 and return line 24 are commercially available tubes or pipes that carry refrigerant in liquid or gas form. They may be made of plastic, copper or from a range of other materials. Generally, all refrigerant lines depicted in FIGS. 3-6 may be selected by one of ordinary skill in the art based on system characteristics such as volume, pressure, temperature, and refrigerant type. For this reason, the various lines are not individually identified, but may be referred to as return or supply lines where such a distinction is significant.

Refrigerant supplied by condenser unit 10 enters an expansion device 18 that generates a stream of cool refrigerant in liquid, vapor, or partial liquid and partial vapor form which is then supplied to a refrigerant vessel 20 (henceforth referred to simply as vessel 20). Expansion device 18 may be a conventional thermal expansion valve, a mixed-phase regulator and surge vessel (reservoir) or the like.

Vessel 20 is typically a cylindrical tank that holds refrigerant in liquid and vapor form. Vessel 20 is typically placed on a floor or the ground such that its top is further from the ground and its bottom is closer to the ground. Therefore, liquid phase refrigerant naturally resides at the bottom of vessel 20 and vapor phase refrigerant naturally fills the cavity above the liquid at the top of vessel 20. In certain embodiments, vessel 20 is cylindrical in form and is oriented horizontally and has a horizontal axis through its center; in other embodiments vessel 20 is oriented vertically and has a vertical axis through its center. Vessel 20 has a number of tubes, or lines that emanate from it; the lower lines (with respect to a vertical axis) supply liquid phase refrigerant and the higher lines supply vapor phase refrigerant. Lines that supply mixed phase refrigerant are typically placed closer to the vertical center of vessel 20. Additionally, in certain embodiments there are lines that suck refrigerant in liquid phase that enter vessel 20 from the top and terminate towards the bottom. Such lines are often referred to as “dip tubes” since the tube dips into the liquid region of vessel 20.

Vessel 20 supplies cool refrigerant, through a supply line 26, to a primary heat exchanger 40 which forms and a block of ice when device 2 operates in an ice make mode, or phase, and melts the ice when device 2 operates in an ice melt mode. Primary heat exchanger 40 includes an insulated ice tank 42, which houses a number of coils 44 which run vertically through ice tank 42. In operation, coils 44 are surrounded by fluid and/or ice depending on the current mode of operation. Primary heat exchanger 40 further includes a lower header assembly connected through coils 44 to an upper header assembly. The upper and lower header assemblies (not identified in the figures) exchange fluid and vapor with other components with supply and return lines as previously discussed. The form of primary heat exchanger 40 has been referred to as a box spring heat exchanger.

When device 2 supplies cooling to air handler 60 it releases cold refrigerant from vessel 20 through supply line 26. The cold refrigerant is pumped by pump 50 through an evaporator coil 62 which is integrated with air handler 60. In contrast, to prior art devices there is no inline expansion device; thus, evaporator coil 62 is flooded with liquid refrigerant. Air handler 60 blows warm air across evaporator coil 62 resulting in a cooling of the air and a heating of the refrigerant passing through evaporator coil 62. Depending on various factors, including pressure and the temperature of the ambient air, some or all of the refrigerant may transform to vapor. This warmer refrigerant, typically in liquid and vapor form, returns to vessel 20 through a return line 28.

In certain embodiments, integration between evaporator coil 62 and air handler 60 is accomplished by physically incorporating evaporator coil 62 within the housing of air handler 60 such that room temperature or warmer air blows across the coils of evaporator coil 62. Integration may be performed in various other ways in other embodiments without departing from the scope of the subject invention.

A secondary heat exchanger 70 is included in certain embodiments to ensure that the block of ice formed inside tank 42 forms evenly in shape and depth.

### Modes of Operation

FIGS. 4-6 illustrate the flow of refrigerant through RTESC system 1 in each of the three modes of operation, respectively: ice make, ice melt, and direct cooling. The thick closed line labeled A in each figure indicates which components and refrigerant lines operate during each mode. The dashed lines indicate the flow of warmer refrigerant or gas phase refrigerant while the solid lines indicate the flow of cool refrigerant.

The three modes of operation are typically implemented by a series of valves (not shown) that control the flow of refrigerant through various components, depending on the operating mode currently selected. The operating mode is typically selected by a computer controller and the mode may be selected based on any of a variety of factors including inter alia time of day, external temperature, refrigerant temperature, water temperature in tank 42, and the amount of ice in tank 42.

### Ice Make Mode

FIG. 4 illustrates the flow of refrigerant through RTESC system 1 when device 2 is operating in ice make mode. RTESC system 1 uses a condenser unit 10 to provide cool refrigerant during ice-make mode when it forms a block of ice inside tank 42. RTESC system 1 typically shifts into an ice-make mode during non-peak hours to shift energy load, i.e. electricity usage, to a lower price period.

During ice make mode, condenser unit 10 directs cold refrigerant into supply line 22. In certain embodiments, an inline expansion device 18 further lowers the refrigerant fluid pressure and therefore cools the refrigerant before it enters vessel 20.

The cooler refrigerant in vessel 20 flows to the bottom and is sucked through a supply line 26 and enters coils 44 at the bottom of primary heat exchanger 40. The refrigerant absorbs heat from the relatively warmer surrounding water in ice tank 42 and due to the low boiling temperature of the refrigerant boils and changes to gaseous phase. The refrigerant in gaseous form then rises through coils 44. The refrigerant phase change absorbs heat from the surrounding water which freezes the water and generates a block of ice. Effectively, when device 2 operates in ice make mode tank 42 in conjunction with coils 44 form a heat exchanger, transforming cold liquid refrigerant into warm refrigerant vapor and in the process freezing water to make ice.

Refrigerant in vapor form rises to the top of tank 42 where it is piped into the top of vessel 20. The refrigerant in gas form is then sucked out of vessel 20 through a return line and piped back to condenser unit 10 which transforms it back into liquid form.

It may be appreciated that FIG. 4 shows an embodiment with two paths for vapor to flow from coils 44 through an upper header. One path flows into vessel 20 and one path flows directly out of device 2 and into condenser unit 10. Experimentation has shown that this approach results in a more uniform block of ice being formed inside tank 42.

### Ice Melt Mode

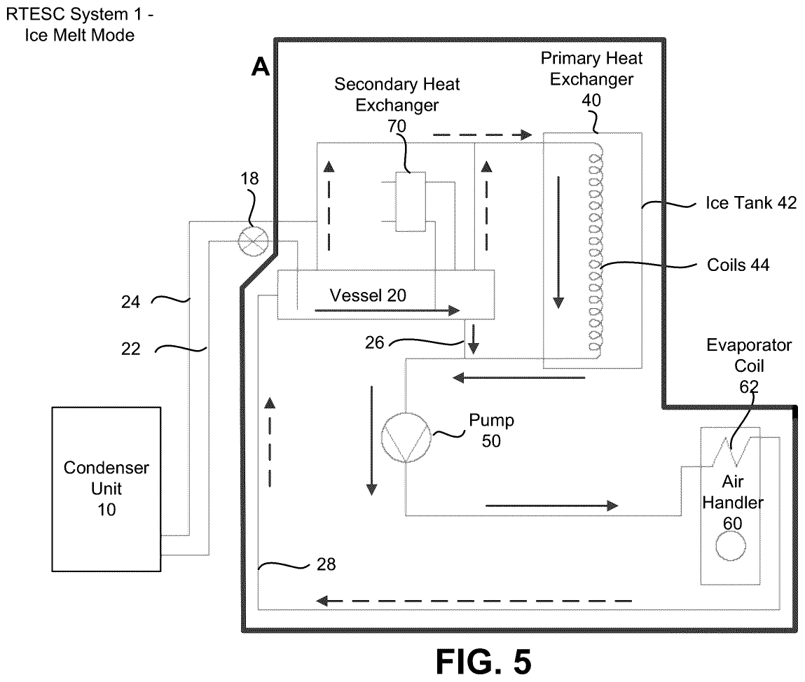

FIG. 5 illustrates the flow of refrigerant through RTESC system 1 when device 2 is operating in ice melt mode. In ice melt mode device 2 operates to provide cool liquid to evaporator coil 62, which is integrated with air handler 60. Condenser unit 10 may be turned off; thus, no energy or refrigerant is required from condenser unit 10, which reduces energy requirements when operating in this mode.

Refrigerant in vessel 20 is typically in a mixed phase, i.e. partially in vapor phase and partially in liquid phase. The cooler, liquid phase, refrigerant in vessel 20 flows to the bottom. The vapor phase refrigerant is sucked out of vapor lines emanating from the top of vessel 20 and enter coils 44 from the top. The vapor phase refrigerant condenses as it descends through coils 44 to form cool liquid phase refrigerant.

Refrigerant pump 50 draws cool liquid refrigerant from the bottom vessel 20 and from the bottom of coils 44 through supply line 26 and pumps it to evaporator coil 62 which is integrated with air handler 60. As the liquid refrigerant passes through evaporator coil 62, inside air handler 60, it absorbs heat. Thus, some of the liquid refrigerant evaporates and a mixture of warm vapor and liquid returns to refrigerant vessel 20 through return line 28. In refrigerant vessel 20 the returned liquid mixes with cold refrigerant at the bottom of refrigerant vessel 20. The vapor is then siphoned back to primary heat exchanger 40 and enters coils 44 from the top. The coils are immersed in ice or cold water and consequently the vapor phase refrigerant condenses back into a cold liquid phase form and flows to the bottom of coils 44 where it is pumped back out, thus completing the cycle.

Due to the continuous injection of warm vapor phase refrigerant into coils 44 from the top the ice block in tank 42 continuously melts from the top down. This continues until the entire block of ice melts or system 1 switches to ice make mode.

It may be appreciated that standard AC units would typically include an expansion device between pump 50 and evaporator coil 62 to generate cool refrigerant. However, device 2 does not require an expansion device here due to the presence of primary heat exchanger 40. This results in a simpler design and eliminates a component that would otherwise draw electrical power.

### Direct Cooling Mode

Direct cooling mode takes advantage of device 2 to provide cooling from condenser unit 10 to air handler 60 without using primary heat exchanger 40. This is advantageous, for example, if cooling is requested but there is no ice or not enough ice in ice tank 42 to warrant using primary heat exchanger 40.

When operating in direct cooling mode, condenser unit 10 directs cold refrigerant into supply line 22. In certain embodiments, an inline expansion device 18 lowers the refrigerant fluid pressure and therefore further cools the refrigerant before it enters vessel 20. In other embodiments, expansion device 18 is not used in direct cooling mode and the cold refrigerant flow directly into vessel 20.

The cool refrigerant flows to the bottom of vessel 20 where it is sucked out by pump 50 through supply line 26. Refrigerant pump 50 draws cool liquid refrigerant from the bottom vessel 20 and pumps it to evaporator coil 62 which is integrated with air handler 60. As the liquid refrigerant passes through evaporator coil 62, inside air handler 60, it absorbs heat. Some of the liquid refrigerant evaporates, i.e. is transformed to gas or vapor phase and a mixture of warm vapor and liquid returns to refrigerant vessel 20 through return line 28. In refrigerant vessel 20 the returned liquid mixes with cold refrigerant at the bottom of refrigerant vessel 20. The vapor is sucked back to condenser 10 where is again transformed to cool liquid phase refrigerant, thus completing the cycle.

Upon reading this disclosure, those of skill in the art will appreciate that while particular embodiments and applications have been illustrated and described herein, the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A thermal storage and cooling system, comprising:
a condenser unit configured to receive warm refrigerant and supply cool refrigerant;
a first supply line capable of supplying the cool refrigerant from the condenser unit to a vessel;
a second supply line that carries the cool refrigerant from the bottom of the vessel to either a primary heat exchanger or to an evaporator coil inside an air handler;
the primary heat exchanger, comprising:
a tank that holds ice and water; and
a plurality of coils that run vertically from the bottom of the tank to the top of the tank through the ice and water;
a first return line that carries gas phase refrigerant and connects the coils at the top of the tank to the condenser unit and also connects the coils at the top of the tank to the top of the vessel;
a refrigerant pump configured to suck the cool refrigerant from the bottom of the vessel and from the bottom of the tank through the second supply line and direct it to the evaporator coil; and
the air handler, wherein the evaporator coil is integrated inside the air handler, enabling the air handler to blow warm air across the evaporator coil, thus generating a stream of cooler air and warming the cold refrigerant, wherein after passing through the evaporator coil the warm refrigerant is returned through a second return line to the vessel.

2. The system of claim 1 wherein the system is configured to operate in one of three three modes: ice make mode, ice melt mode and direct cooling mode, wherein ice make mode generates ice inside the tank, ice melt mode uses the ice in the tank to generate cooling, and direct cooling mode uses the condenser unit to provide cooling.

3. The system of claim 2 wherein when operating in ice make mode the second supply line is configured to direct the cold refrigerant from the bottom of the vessel only to the bottom of the coils in the tank, wherein the water in the tank warms the refrigerant causing it to boil and generate gas phase refrigerant that rises through the coils.

4. The system of claim 2 wherein, when operating in ice melt mode:
the condenser unit is turned off and doesn't supply refrigerant;
vapor phase refrigerant inside the vessel is sucked out the vessel through vapor lines emanating from the top of vessel and enter the coils at the top of the tank;
the vapor phase refrigerant condenses as it descends through the coils to the bottom of the tank to form cool liquid phase refrigerant; and
the second supply line is configured to direct the cold liquid phase refrigerant from the bottom of the vessel and from the coils at the bottom of the tank to the evaporator coil inside the air handler.

5. The system of claim 2 wherein, when operating in direct cooling mode:
the condenser unit generates cool refrigerant which flows through the first supply line into the vessel;
the cool refrigerant at the bottom of vessel is sucked out by the pump through the second supply line and is directed to the evaporator coil;
no refrigerant is drawn from the tank;
the action of the air handler warms the refrigerant inside the evaporator coil, resulting in warmer liquid and gas phase refrigerant;
the warmer liquid and gas phase refrigerant returns to the vessel through the second return line; and
gas phase refrigerant inside the vessel returns to the condenser unit through a return line where it is transformed to cool liquid phase refrigerant.

6. The system of claim 1, further comprising an expansion device, wherein the expansion device is inline with the first supply line that carries the cool refrigerant from the condenser unit to the vessel, further cooling the refrigerant.

7. A thermal storage and cooling device that integrates with a condenser unit and an air handler, comprising:
a first supply line capable of supplying the cool refrigerant from the condenser unit to a vessel;
a second supply line that carries the cool refrigerant from the bottom of the vessel to either a primary heat exchanger or to an evaporator coil;
the primary heat exchanger, comprising:
a tank that holds ice and water; and
a plurality of coils that run vertically from the bottom of the tank to the top of the tank through the ice and water;
a first return line that either directs gas phase refrigerant from the coils at the top of the tank to the condenser unit or directs gas phase refrigerant from the top of the vessel to the coils at the top of the tank;
a refrigerant pump configured to suck the cool refrigerant from the bottom of the vessel and from the bottom of the tank through the second supply line and direct it to the evaporator coil;
wherein the evaporator coil is integrated inside the air handler, enabling the air handler to blow warm air across the evaporator coil, thus generating a stream of cooler air and warming the cold refrigerant, wherein after passing through the evaporator coil the warm refrigerant is returned through a second return line to the vessel.

8. The device of claim 7 wherein the device is configured to operate in one of three three modes: ice make mode, ice melt mode and direct cooling mode, wherein ice make mode generates ice inside the tank, ice melt mode uses the ice in the tank to generate cooling, and direct cooling mode uses the condenser unit to provide cooling.

9. The device of claim 8 wherein when operating in ice make mode the second supply line is configured to direct the cold refrigerant from the bottom of the vessel only to the bottom of the coils in the tank, wherein the water in the tank warms the refrigerant causing it to boil and generate gas phase refrigerant that rises through the coils.

10. The device of claim 8 wherein, when operating in ice melt mode:
refrigerant is not supplied by the condenser unit to the device;
vapor phase refrigerant inside the vessel is sucked out the vessel through vapor lines emanating from the top of vessel and enter the coils at the top of the tank;
the vapor phase refrigerant condenses as it descends through the coils to the bottom of the tank to form cool liquid phase refrigerant; and
the second supply line is configured to direct the cold liquid phase refrigerant from the bottom of the vessel and from the coils at the bottom of the tank to the evaporator coil integrated with the air handler.

11. The device of claim 8 wherein, when operating in direct cooling mode:
the vessel receives cool refrigerant from the condenser unit through the first supply line;
the cool refrigerant at the bottom of vessel is sucked out by the pump through the second supply line and is directed to the evaporator coil;
no refrigerant is drawn from the tank;
the action of the air handler warms the refrigerant inside the evaporator coil, resulting in warmer liquid and gas phase refrigerant;
the warmer liquid and gas phase refrigerant returns to the vessel through the second return line; and
gas phase refrigerant inside the vessel returns to the condenser unit through a return line where it is transformed to cool liquid phase refrigerant.

12. The device of claim 7, further comprising an expansion device, wherein the expansion device is inline with the first supply line that carries the cool refrigerant from the condenser unit to the vessel, further cooling the refrigerant.
